(19) United States
(12) Patent Application Publication
(10) Pub. No.: US 2005/0108040 A1
(43) Pub. Date: May 19, 2005

(54) Method for measuring a value of a driver quantity

(76) Inventors: Manfred Moser, Reutlingen (DE); Sonja Fritze, Reutlingen (DE); Michael Pfeiffer, Reutlingen (DE)

Correspondence Address: KENYON & KENYON, ONE BROADWAY, NEW YORK, NY, 10004, US

(21) Appl. No.: 10/962,102

(22) Filed: Oct. 7, 2004

(30) Foreign Application Priority Data
Oct. 8, 2003 (DE) 103 46 613.4

(51) Int. Cl. G06F 17/60

(52) U.S. Cl. 705/1

(57) ABSTRACT

A method is described for measuring a value of a driver quantity of a system, to which a number of system quantities are assigned, each system quantity being assigned at least one property and at least one value, the value of the driver quantity being computed under consideration of the at least one value of the defined system quantities which, on the basis of their at least one property, meet at least one condition. The driver quantity is thus clearly defined yet may be a function of any number of system quantities within the system. Using the driver quantity, a certain aspect within the system may be detected either statically or dynamically, i.e., as a function of time. On this basis statistics may be generated. In addition, this method opens up possibilities for interpretation.

### FIELD OF THE INVENTION

The present invention relates to a method for measuring a value of a driver quantity, a device for measuring a value of a driver quantity, as well as a corresponding computer program and computer program product.

### BACKGROUND INFORMATION

Commercially sold project planning tools, such as MS Project or SAPPS, are currently known. These project planning tools are provided within a business process for project tracking, evaluation, proactive resource management, or for data exchange with other systems.

Strategies used for improving business processes use no defined drivers or only poorly defined drivers. These usually do not allow direct conclusions regarding reasons for errors or the like.

In light of this background, the object of the present invention is to improve the possibility of observing and/or monitoring a system in general, which may have an arbitrarily complex overall design.

### SUMMARY OF THE INVENTION

For this purpose, a method for measuring a value of a driver quantity, a device for measuring a value of a driver quantity, a computer program, and a computer program product are presented.

In the method of the present invention for measuring a value of a driver quantity of a system to which a number of system quantities are assigned, each system quantity having at least one property and at least one value assigned to it, the value of the driver quantity is computed under consideration of at least one value of those defined system quantities which, on the basis of their at least one property, meet at least one condition. The driver quantity is thus clearly defined yet may be a function of any number of system quantities within the system. Using the driver quantity, a certain aspect within the system may be detected either statically or dynamically, i.e., as a function of time. Statistics may be generated on this basis. In addition, the method opens up possibilities for interpretation, for example, regarding a function of the system.

When executing the method, those system quantities which meet the at least one condition on the basis of their at least one property for a defined state of the system may be determined. The condition may be defined or it may be a function of the state, e.g., system-dependent. The at least one condition, which system quantities meet on the basis of their property in a state of the system, may be characterized, for example, by the system quantities being activated or passivated during the state. The values of those system quantities which are then used for computing the driver quantity may be a function of the particular property in the state or may be a function of a characteristic of the system quantity regardless of the state or the property.

To compute the driver quantity as a function of the at least one value of the defined system quantity, different formalized theories or mathematical models may be used. It is conceivable to use values of different system quantities, which in turn have different properties, for computing the value of the driver quantity. Values of a first group of system quantities, which have a first property, values of a second group of system quantities, which have a second property, values of a third group of system quantities, which have a third property, etc. may be used in this process.

In a preferred embodiment of the present invention, an electronic computing unit may be used to compute the value of the driver quantity for a system designed as a project landscape, a number of system quantities designed as work packages. The project landscape is then divided into work packages. The sum of work packages may be located in the working memory of a functional unit. The work packages processed within a measurement period may be measured using the method.

The “relative workload fulfillment” RWF may be computed as a possible driver quantity. The RWF is equal to the sum of all logged off work packages (WP) divided by the sum of all work packages (WP) in the working memory.
RWF=Σ of all logged off work packages WP/Σ of all WP in the working memory

“On-time delivery” OTD may be computed as an additional driver quantity. An important criterion for this is the measurement of the timely processing of work packages. All work packages of a project which are located on a time-critical path are measured in the measuring period. Dividing the sum of all logged off work packages (WP) having OTD=1 by the sum of all work packages (WP) logged off in a timely manner yields the OTD index.
OTD=Σ of all logged off work packages WP/all WP in the working memory.

The “quick digital work package quality” QDQ may be computed as an additional driver quantity. This is an evaluation of the output qualities of work packages by a user of work packages. Such an evaluation is digital (0 or 1) and may take place within a week, for example.

The sum of all work package evaluations within a measuring period provides the RPQ (resulting quality of the development process). The RPQ is equal to the sum of all logged off work packages (WP) having QDQ=1 divided by the sum of all logged off work packages (WP).
RPQ=Σ of all logged off work packages WP having QD2=1/Σ all logged off WP.

It is also possible to calculate a relative value added “relative added value fulfillment” RAVF as a further driver quantity using the method. For measuring productivity within a project organization, the work packages are weighted using a monetary value in addition to the time value. The index is obtained by reference to the actually performed development work. The RAVF is equal to the sum of all logged off work packages (WP), in particular their monetary value, divided by the sum of an actual development budget:
RAVF=of all logged off work packages (WP) (monetary value in euros)/actual development budget.

These are only a few examples of driver quantities which may be computed according to the present invention. Basically any conceivable driver quantity of the project landscape, which is a function of any number of values of any work packages in any combination, may be computed.

The device for measuring a value of a driver quantity of a system which has a number of units, each having at least one property and at least one associated value, has an electronic computing unit which computes the value of the driver quantity under consideration of the at least one value of those units which, on the basis of their at least one property, meet at least one condition. Using this device according to the present invention, the driver quantity may be computed and the values required for the computation may be determined via automation in a particularly simple manner.

The device may have at least one interface for exchanging data between at least two users, databases of the at least two users being synchronized via an automated mechanism. Exchangeable data here may be values of the system quantities or work packages. Because the databases are synchronized via an automated mechanism, data exchange between service providers and clients, i.e., the users, may be simplified. An agreement may be reached here on who acts as the “master,” i.e., whose database is valid in case of doubt. This synchronization may follow rules which may be as complex as desired depending on the requirements.

The computer program according to the present invention having program code means is used for performing all steps of the method according to the present invention when this computer program is executed on a corresponding electronic computing unit of the device according to the present invention. The driver quantities may thus be computed in a simple way in a short time. A software package linked to the computer program may be flexible in its measurement setting and use for a project group which may have a number of units or work packages. Any type of project or sequence of work packages may thus be tracked and measured. However, a unique standard prevails within a project group, which may include several projects, due to the software defined by the computer program.

The computer program according to the present invention may be designed as software modules and may have a number of versions, and it may start a version intended for measuring the determined driver quantity for computing a value of a determined driver quantity via a version edition loaded from an initial file. The correct version may thus be started automatically every time as a function of a property of the driver quantity or as a function of the driver quantity itself. This version may be handled internally as a global variable.

The computer program according to the present invention may have additional software for exchanging data with another system, this software changing at least one driver quantity as needed as a function of a change in user data. Data exchange with other systems, in particular planning systems, may thus be achieved. The driver quantities are automatically affected due to automatic feedback for the system when client data or service provider data changes. This in turn makes a timely counterlink possible.

Further advantages and embodiments of the present invention are derived from the description and the attached drawings.

Obviously, the above-named features, which will be further elucidated below, are applicable not only in the combinations described here, but also in other combinations or by themselves without going beyond the scope of the present invention.

The present invention is schematically illustrated in the drawing on the basis of an exemplary embodiment and described in greater detail in the following with reference to the drawing.

### BRIEF DESCRIPTION OF THE DRAWINGS

FIG. 1 schematically shows an illustration of a project landscape.

FIG. 2 schematically shows a preferred embodiment of the device according to the present invention.

### DETAILED DESCRIPTION

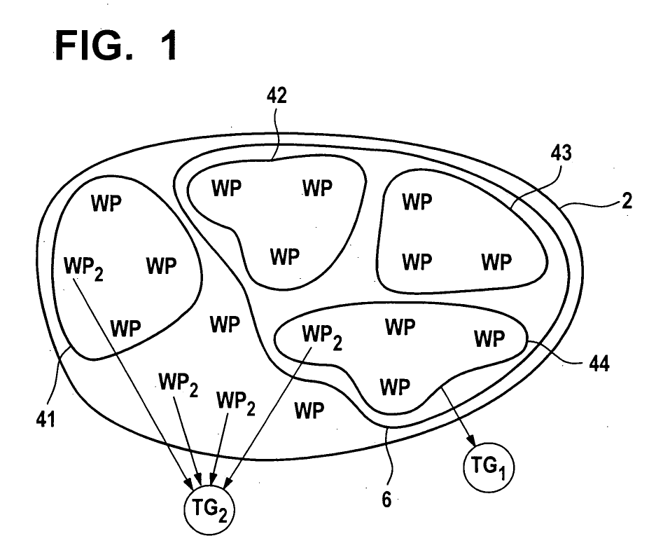

FIG. 1 schematically shows an illustration of a system designed as a project landscape 2, to which a number of system quantities designed as work packages WP are assigned. A plurality of work packages WP may be combined within project landscape 2 to form a project 41, 42, 43, or 44. Furthermore, a plurality of projects 42, 43, 44 may be combined to form a project class 6. In principle, both work packages WP and projects 41, 42, 43, 44, as well as a project class 6, may be labeled as system quantities within project landscape 2.

Driver quantities TG₁ or TG₂ are used for determining or describing one or more system quantities within project landscape 2. According to the present invention, a value of one of driver quantities TG₁ or TG₂ is measurable. The value of driver quantity TG₁ or TG₂ is a function of at least one value of at least one work package WP. In a determined state during a measurement of the value of driver quantity TG₁ or TG₂, those work packages WP which meet a defined condition during the state on the basis of at least one property may be taken into account.

In this case, those work packages WP associated with project 44 are taken into account for computing the value of driver quantity TG₁. Values of work package WP₂ are taken into account for computing the value of driver quantity TG₂. In this case these work packages WP₂ are associated with different projects 41 or 44, but they may have a certain shared property.

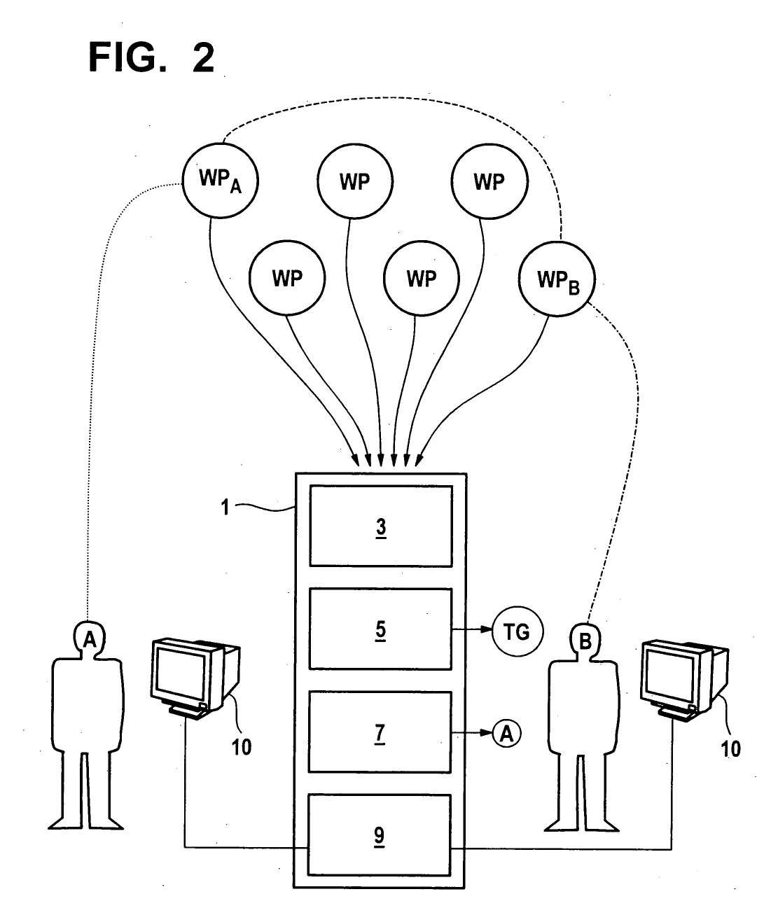

FIG. 2 schematically shows, among other things, a device 1 according to the present invention for performing the method according to the present invention. Device 1 has a detector unit 3, an electronic computing unit 5, an analyzer unit 7, and an interface 9.

It is provided that a computer 10 or other suitable data exchange or communication devices of two users A and B are connected via interface 9. The two users A and B may exchange data via interface 9, the databases of the two users A and B being able to be synchronized via an automated mechanism.

A work package WP_{A} may be affected by actions of user A and/or affect his/her interests (dotted line). A work package WP_{B} may be similarly affected by actions of user B and/or affect his/her interests (dot-dashed line). The two work packages WP_{A} and WP_{B} may be connected by reciprocal action and thus mutually affect one another (dashed line). The two users A and B may be informed of the effects of this reciprocal action by data exchange via interface 9; interface 9 may be influenced by inputting or modifying data.

Values of different work packages WP may be detected by detector unit 3 within device 1. Electronic computing unit 5 may be used to compute a driver quantity TG as a function of the at least one value of work package WP. Using analyzer unit 7, thus acquired knowledge about the project landscape or for one or more work packages WP may be subjected to an analysis. An analysis result A, for example, may thus be determined from a driver quantity TG computable according to the present invention.

1. A method for measuring a value of a driver quantity of a system, comprising:
assigning to the system a number of system quantities;
assigning to each system quantity at least one property and at least one value; and
computing a value of driver quantity in consideration of the at least one value of those system quantities that are defined and that, on the basis of the at least one property of each respective defined system quantity, meet at least one condition.

2. The method as recited in claim 1, further comprising:
determining the system quantities that meet the at least one condition on the basis of the at least one property of each respective defined system quantity for a defined state of the system.

3. The method as recited in claim 1, further comprising:
computing the value of the driver quantity as a function of at least one intermediary value; and
computing the at least one intermediary value in consideration of the at least one value of the system quantities that have at least one determined property.

4. The method as recited in claim 1, further comprising:
computing the value of the driver quantity as a function of at least one sum; and
computing the at least one sum as a function of the at least one value of the system quantities that have at least one determined property.

5. The method as recited in claim 1, wherein:
an electronic computing unit is used to compute the value of the driver quantity for a system designed as a project landscape, to which a number of system quantities designed as work packages are assigned.

6. A device for measuring a value of a driver quantity of a system, comprising:
an arrangement for assigning to the system a number of system quantities;
an arrangement for assigning to each system quantity at least one property and at least one value; and
an electronic computing unit for computing a value of driver quantity in consideration of the at least one value of those system quantities that are defined and that, on the basis of the at least one property of each respective defined system quantity, meet at least one condition.

7. The device as recited in claim 6, further comprising:
an automated mechanism
at least one interface for exchanging data between at least two users, wherein:
databases of the at least two users are synchronized via the automated mechanism.

8. A computer program, comprising:
a program code arrangement that when executed one of a computer and an electronic computing unit results in a performance of
assigning to a system a number of system quantities;
assigning to each system quantity at least one property and at least one value; and
computing a value of driver quantity in consideration of the at least one value of those system quantities that are defined and that, on the basis of the at least one property of each respective defined system quantity, meet at least one condition.

9. The computer program as recited in claim 8, wherein:
the computer program is designed as software modules and has a number of versions, and
the computer program starts a version intended for measuring the determined driver quantity in order to compute a value of the determined driver quantity via a version edition loaded from an initial file.

10. The computer program as recited in claim 8, further comprising:
additional software for exchanging data with another system, the additional software changing the driver quantity as needed as a function of a change in data of a user.

11. The computer program as recited in claim 8, wherein:
the computer program is a computer program product stored on a computer-readable data medium.
